(19) United States
(12) Patent Application Publication
(10) Pub. No.: US 2025/0201226 A1
(43) Pub. Date: Jun. 19, 2025

(54) SOUND SIGNAL PROCESSING DEVICE AND METHOD, AND RELATED DEVICE

(71) Applicant: HUAWEI TECHNOLOGIES CO., LTD., Shenzhen (CN)

(72) Inventors: Boyan HUANG, Harbin (CN); Zhihua YANG, Beijing (CN); Baiyu LIU, Harbin (CN); Weiqi SUN, Harbin (CN); Xiuming SONG, Harbin (CN)

(21) Appl. No.: 19/062,940

(22) Filed: Feb. 25, 2025

Related U.S. Application Data
(63) Continuation of application No. PCT/CN2023/098338, filed on Jun. 5, 2023.

(30) Foreign Application Priority Data
Aug. 31, 2022 (CN) 202211055930.8

(51) Int. Cl. G10K 11/178; H04R 1/10; H04R 3/04

(52) U.S. Cl. CPC G10K 11/17823; H04R 1/1083; H04R 3/04; G10K 2210/3028; H04R 2460/01; H04R 2460/13

(57) ABSTRACT

A sound signal processing device is provided, including: a first bone conduction sensor, configured to acquire a sound at a first time, to obtain a first sound signal; and a second bone conduction sensor, configured to acquire a second sound signal at the first time. The first bone conduction sensor is in contact with a sound producer, the first sound signal carries a voice signal generated by the sound producer and an ambient noise. The second bone conduction sensor is not in contact with the sound producer. Noise reduction is performed on the first sound signal by using the second sound signal. An included angle between a signal acquisition direction of the second bone conduction sensor when the second bone conduction sensor is worn and a sound production direction of the sound producer is greater than or equal to 90 degrees.

### CROSS-REFERENCE TO RELATED APPLICATIONS

This application is a continuation of International Application No. PCT/CN2023/098338, filed on Jun. 5, 2023, which claims priority to Chinese Patent Application No. 202211055930.8, filed on Aug. 31, 2022. The disclosures of the aforementioned applications are hereby incorporated by reference in their entireties.

### TECHNICAL FIELD

This application relates to the field of audio and video signal processing, and in particular, to a sound signal processing device and method, and a related device.

### BACKGROUND

A working principle of a bone conduction sensor is to collect a vibration signal generated by an organ such as a skull or a throat when a sound producer makes a sound, and convert the acquired vibration signal into an electrical signal, to obtain a sound signal. Due to a noise-shielding advantage of a transmission path of the bone conduction sensor, the bone conduction sensor is more suitable to work in a strong-noise environment than an air conduction microphone.

However, in an actual application scenario, a sound signal obtained by using the bone conduction sensor still carries a noise. Therefore, a solution for performing noise reduction on the sound signal acquired by the bone conduction sensor needs to be urgently proposed.

### SUMMARY

Embodiments of this application provide a sound signal processing device and method, and a related device. A first bone conduction sensor is in contact with a sound producer, and a second bone conduction sensor is not in contact with the sound producer. Noise reduction is performed on a first sound signal acquired by the first bone conduction sensor by using a second sound signal acquired by the second bone conduction sensor, which helps remove an ambient noise in the first sound signal, to obtain a cleaner voice signal. In addition, if an included angle between a signal acquisition direction of the second bone conduction sensor when the second bone conduction sensor is worn and a sound production direction of the sound producer is greater than or equal to 90 degrees, a voice produced by the sound producer cannot directly enter the second bone conduction sensor through air, which helps avoid removing the voice signal from the first sound signal, to obtain a high-quality voice signal.

To resolve the foregoing technical problem, embodiments of this application provide the following technical solutions.

According to a first aspect, an embodiment of this application provides a sound signal processing device. For example, the sound signal processing device may be a wearable device. The device includes a first bone conduction sensor and a second bone conduction sensor. The first bone conduction sensor is in contact with a sound producer, and the first bone conduction sensor is configured to acquire a sound at a first time, to obtain a first sound signal. The second bone conduction sensor is not in contact with the sound producer, and the second bone conduction sensor is configured to acquire a second sound signal at the first time. That is, the first bone conduction sensor and the second bone conduction sensor may synchronously perform a sound acquisition operation. The second sound signal is used to perform noise reduction on the first sound signal, an included angle between a signal acquisition direction of the second bone conduction sensor when the second bone conduction sensor is worn and a sound production direction of the sound producer is greater than or equal to a preset angle threshold, and the preset angle threshold is greater than or equal to 90 degrees. For example, the signal acquisition direction of the second bone conduction sensor when the second bone conduction sensor is worn may be an orientation in which the second bone conduction sensor is worn, and the sound production direction of the sound producer may be an orientation of a mouth of the sound producer. In an embodiment, with the orientation of the mouth of the sound producer as the front, a position at which the second bone conduction sensor is worn corresponds to a position of a part behind the mouth of the sound producer.

In this application, a person skilled in the art finds in an experiment that some noises in an environment can penetrate a bone conduction sensor, that is, an ambient noise exists in a sound signal acquired by the bone conduction sensor. Both the first bone conduction sensor and the second bone conduction sensor acquire sounds at the first time. Because the first bone conduction sensor is in contact with the sound producer, the first sound signal carries a voice signal generated by the sound producer and the ambient noise. Because the second bone conduction sensor is not in contact with the sound producer, the second sound signal acquired by the second bone conduction sensor carries a large quantity of ambient noises. Noise reduction is performed on the first sound signal by using the second sound signal, which helps remove the ambient noise from the first sound signal, to obtain a cleaner voice signal. In addition, if the included angle between the signal acquisition direction of the second bone conduction sensor when the second bone conduction sensor is worn and the sound production direction of the sound producer is greater than or equal to 90 degrees, a voice produced by the sound producer cannot directly enter the second bone conduction sensor through air, and needs to be reflected in the air for at least one time before being acquired by the second bone conduction sensor. This helps reduce a possibility that the second sound signal carries the voice signal, and helps avoid removing the voice signal from the first sound signal, to obtain a high-quality voice signal.

In an embodiment, the included angle between the signal acquisition direction of the second bone conduction sensor when the second bone conduction sensor is worn and the sound production direction of the sound producer is equal to 180 degrees.

In an embodiment, the sound signal processing device may further include a processor. The processor is configured to: obtain a first narrowband noise from the second sound signal, and perform noise reduction on the first sound signal by using the first narrowband noise. A narrowband noise has a center frequency and a bandwidth, and a bandwidth of a frequency band of the narrowband noise is less than the center frequency of the narrowband noise. For example, the first narrowband noise may be a periodic narrowband noise, and the periodic narrowband noise is a plurality of periodic sound waves existing in a narrowband noise in a fourth sound signal. In this application, when a decibel of a narrowband noise in the environment is excessively high, the narrowband noise can penetrate the bone conduction sensor, causing the bone conduction sensor to carry the narrowband noise in the environment. When the sound producer is in a scene near a factory building, an electronic device, or a coal mine, an engine, the electronic device, or the like can produce a high-decibel narrowband noise. As a result, the high-decibel narrowband noise penetrates the bone conduction sensor, causing interference to the acquired first sound signal. Because the second bone conduction sensor is not in contact with the sound producer, the narrowband noise in the environment exists in the second sound signal. The narrowband noise in the environment is obtained from the second sound signal, and noise reduction is performed on the first sound signal, so that a relatively clean voice signal can be obtained in the scene such as the factory building, the electronic device, or the coal mine. In other words, this solution can be adapted to a strong-noise application scenario such as the factory building, the electronic device, or the coal mine.

In an embodiment, the processor is specifically configured to obtain the first narrowband noise from the second sound signal by using an adaptive filter. For example, the adaptive filter may be a linear adaptive filter. The adaptive filter is a filter that can automatically adjust performance based on an input sound signal, to perform digital signal processing, and a coefficient of the adaptive filter can be adaptively adjusted. Specifically, the processor may input the second sound signal delayed by D sampling points into the linear adaptive filter, to obtain the first narrowband noise that is output by the linear adaptive filter. In this application, the adaptive filter is used to obtain the first narrowband noise from the second sound signal. This not only provides a relatively simple implementation solution for obtaining the first narrowband noise from the second sound signal, but also can adaptively process the second sound signal in real time, so that a scenario, such as a call, that has a relatively high real-time requirement can be met, thereby helping expand implementation scenarios of this solution.

In an embodiment, the processor is specifically configured to: adjust an amplitude and/or a phase of a first narrowband signal to obtain a second narrowband signal, and perform noise reduction on the first sound signal by using the second narrowband signal. In this application, because the amplitude of the first narrowband signal may be different from an amplitude of a narrowband noise in the first sound signal, the amplitude of the first narrowband signal is adjusted, which helps improve consistency between amplitudes of the second narrowband signal and the narrowband noise in the first sound signal, thereby helping improve quality of a noise-reduced first sound signal. The phase of the first narrowband signal is adjusted, which helps implement alignment between the second narrowband signal and the narrowband noise in the first sound signal in a phase dimension, thereby helping improve quality of the noise-reduced first sound signal.

In an embodiment, the processor is specifically configured to input the first narrowband signal and the first sound signal into an adaptive noise canceller, to obtain a second narrowband signal output by the adaptive noise canceller. The adaptive noise canceller is an application manner of the adaptive filter. That is, the adaptive noise canceller may be an adaptive filter. In this application, the adaptive noise canceller is used to adjust the amplitude and/or the phase of the first narrowband signal. This provides a relatively simple implementation solution, and can adaptively process the first narrowband signal in real time, so that a scenario, such as a call, that has a relatively high real-time requirement can be met, thereby helping expand implementation scenarios of this solution.

In an embodiment, the sound signal processing device is a hat, and the second bone conduction sensor is fastened to a rear part of a brim of the hat. In this application, the brim of the hat is not in contact with the sound producer, and therefore the second bone conduction sensor fastened to the rear part of the brim of the hat is also not in contact with the sound producer. Because the sound producer faces in a same direction as a front part of the brim of the hat, fastening the second bone conduction sensor to the rear part of the brim of the hat helps further enlarge a distance between the second bone conduction sensor and the sound producer, to further reduce a probability that the second bone conduction sensor acquires an effective voice signal. This avoids a possibility that an effective voice signal in the first sound signal is eliminated or weakened in a process of performing noise reduction on the first sound signal by using the second sound signal, to obtain a higher-quality first sound signal.

In an embodiment, there are at least two first bone conduction sensors in the sound signal processing device, and each first bone conduction sensor is specifically configured to acquire a third sound signal at the first time. The sound signal processing device further includes a processor. The processor is configured to screen, based on energy of at least two third sound signals acquired by the at least two first bone conduction sensors, the at least two third sound signals to obtain at least one selected third sound signal. Specifically, the processor discards a target sound signal from the at least two third sound signals acquired by the at least two first bone conduction sensors, to obtain the at least one selected third sound signal. Energy of the target sound signal meets a first condition. The processor is specifically configured to obtain the first sound signal based on the at least one selected third sound signal. Energy of one sound signal may reflect a strength of the sound signal. A weaker acquired sound signal indicates lower energy of the sound signal, and a stronger acquired sound signal indicates higher energy of the sound signal. The processor may perform weighted summation on only the at least one selected third sound signal to obtain the first sound signal, to discard the target sound signal. Alternatively, the processor may set a weight of each target sound signal to 0 when performing weighted summation on the at least two obtained third sound signals, to discard the target sound signal, and the like. This is not exhaustive herein.

In this application, in a wearing process of the sound signal processing device, a case in which a specific first bone conduction sensor is not closely attached to the sound producer may occur. Therefore, a sound of the sound producer carried in one third sound signal acquired by the first bone conduction sensor is quite weak, and a weak target sound signal can be determined from the at least two third sound signals based on energy of the sound signal, to discard the target sound signal. This helps improve quality of the finally obtained first sound signal, thereby helping improve quality of the noise-reduced first sound signal.

In an embodiment, the processor may determine, in a plurality of manners, whether any third sound signal (for ease of description, hereinafter referred to as a “fifth sound signal”) meets the first condition. In an embodiment, the processor may be specifically configured to: obtain a first average value of energy of at least one third sound signal other than the fifth sound signal in the at least two third sound signals; determine whether a gap between energy of the fifth sound signal and the first average value meets the first condition; and if a determining result is that the gap between the energy of the fifth sound signal and the first average value meets the first condition, determine the fifth sound signal as the target sound signal that needs to be discarded; or if a determining result is that the gap between the energy of the fifth sound signal and the first average value does not meet the first condition, determine that the fifth sound signal does not need to be discarded. The “gap between the energy of the fifth sound signal and the first average value” may be a difference between the energy of the fifth sound signal and the first average value, and the first condition may be that the difference between the energy of the fifth sound signal and the first average value is greater than or equal to a first threshold. Alternatively, the “gap between the energy of the fifth sound signal and the first average value” may be a ratio of the energy of the fifth sound signal to the first average value, and the first condition may be that the ratio of the energy of the fifth sound signal to the first average value is less than or equal to a second threshold. In another embodiment, the processor may be specifically configured to: determine whether the energy of the fifth sound signal is less than or equal to a third threshold; and if a determining result is that the energy of the fifth sound signal is less than or equal to the third threshold, determine the fifth sound signal as the target sound signal that needs to be discarded; or if a determining result is that the energy of the fifth sound signal is not less than or equal to the third threshold, determine that the fifth sound signal does not need to be discarded.

In an embodiment, there are at least two first bone conduction sensors, and each first bone conduction sensor is specifically configured to acquire the third sound signal at the first time. The sound signal processing device further includes a processor. The processor is configured to perform a weighted summation operation based on the at least two third sound signals acquired by the at least two first bone conduction sensors, to obtain the first sound signal. In this application, each third sound signal is acquired at the first time. That is, different first bone conduction sensors synchronously acquire third sound signals. Therefore, it may be considered that a plurality of third sound signals are synchronous (that is, aligned), and it is feasible to weight the plurality of third sound signals. In addition, a simple and effective implementation solution is provided. A hardware noise exists in each third sound signal, and the foregoing hardware noise is a Gaussian noise. Therefore, after different third sound signals are weighted, energy of the Gaussian noise does not increase, but energy of the effective voice signal in the sound signal increases, thereby helping improve a signal-to-noise ratio of the first sound signal.

In an embodiment, the processor is specifically configured to perform an averaging operation based on the at least two third sound signals acquired by the at least two first bone conduction sensors, to obtain the first sound signal. In this application, if there are X signals in the at least two third sound signals, after the X signals are averaged, a Gaussian noise in the first sound signal becomes 1/X of the Gaussian noise in the third sound signal, to help alleviate, to the greatest extent, impact caused by the hardware noise.

According to a second aspect, an embodiment of this application provides a hat. The hat includes a first bone conduction sensor and a second bone conduction sensor. The first bone conduction sensor is in contact with a sound producer, and the second bone conduction sensor is not in contact with the sound producer and is fastened to a rear part of a brim of the hat.

In an embodiment, the first bone conduction sensor is configured to acquire a sound at a first time, to obtain a first sound signal. The second bone conduction sensor is configured to acquire a second sound signal at the first time. The hat further includes a processor, configured to perform noise reduction on the first sound signal by using the second sound signal, to obtain a noise-reduced first sound signal.

The processor provided in the second aspect of this embodiment of this application may further perform the operations performed by the processor in the possible implementations of the first aspect. For specific implementation operations of the second aspect and the possible implementations of the second aspect of this embodiment of this application and beneficial effects brought by each possible implementation, refer to the descriptions in the possible implementations of the first aspect. Details are not described herein again.

According to a third aspect, an embodiment of this application provides a sound signal processing method, and the method may be applied to an electronic device or a chip of an electronic device. For example, the electronic device may be a wearable device, a mobile phone, a tablet computer, a notebook computer, an Internet of Things device, or the like. The sound signal processing method includes: acquiring, by a processor, a sound at a first time by using a first bone conduction sensor, to obtain a first sound signal; acquiring a second sound signal at the first time by using a second bone conduction sensor, where the first bone conduction sensor is in contact with a sound producer, and the second bone conduction sensor is not in contact with the sound producer, where an included angle between a signal acquisition direction of the second bone conduction sensor when the second bone conduction sensor is worn and a sound production direction of the sound producer is greater than or equal to a preset angle threshold, and the preset angle threshold is greater than or equal to 90 degrees; and performing, by the processor, noise reduction on the first sound signal by using the second sound signal, to obtain a noise-reduced first sound signal.

The processor in the sound signal processing method provided in the third aspect of this embodiment of this application may further perform the operations performed by the processor in the possible implementations of the first aspect. For specific implementation operations of the third aspect and the possible implementations of the third aspect of this embodiment of this application and beneficial effects brought by each possible implementation, refer to the descriptions in the possible implementations of the first aspect. Details are not described herein again.

According to a fourth aspect, an embodiment of this application provides a sound signal processing apparatus. The apparatus may be applied to an electronic device or a chip of an electronic device. For example, the electronic device may be a wearable device, a mobile phone, a tablet computer, a notebook computer, an Internet of Things device, or the like. The sound signal processing apparatus includes: an obtaining module, configured to acquire a sound at a first time by using a first bone conduction sensor, to obtain a first sound signal, where the obtaining module is configured to acquire a second sound signal at the first time by using a second bone conduction sensor, where the first bone conduction sensor is in contact with a sound producer, and the second bone conduction sensor is not in contact with the sound producer, where an included angle between a signal acquisition direction of the second bone conduction sensor when the second bone conduction sensor is worn and a sound production direction of the sound producer is greater than or equal to a preset angle threshold, and the preset angle threshold is greater than or equal to 90 degrees; and a noise reduction module, configured to perform noise reduction on the first sound signal by using the second sound signal, to obtain a noise-reduced first sound signal.

The processor in the sound signal processing apparatus provided in the fourth aspect of this embodiment of this application may further perform the operations performed by the processor in the possible implementations of the first aspect. For specific implementation operations of the fourth aspect and the possible implementations of the fourth aspect of this embodiment of this application and beneficial effects brought by each possible implementation, refer to the descriptions in the possible implementations of the first aspect. Details are not described herein again.

According to a fifth aspect, an embodiment of this application provides a computer program product. When the computer program is run on a computer, the computer is enabled to perform the sound signal processing method according to the third aspect.

According to a sixth aspect, an embodiment of this application provides a computer-readable storage medium. The computer-readable storage medium stores a computer program. When the computer program is run on a computer, the computer is enabled to perform the sound signal processing method according to the third aspect.

According to a seventh aspect, an embodiment of this application provides an electronic device. The electronic device may include a processor. The processor is coupled to a memory, and the memory stores program instructions. When the program instructions stored in the memory are executed by the processor, the sound signal processing method according to the third aspect is implemented.

According to an eighth aspect, an embodiment of this application provides a circuit system. The circuit system includes a processing circuit, and the processing circuit is configured to perform the sound signal processing method according to the third aspect.

According to a ninth aspect, an embodiment of this application provides a chip system. The chip system includes a processor, configured to implement functions in the foregoing aspects, for example, sending or processing of data and/or information in the foregoing method. In a possible design, the chip system further includes a memory. The memory is configured to store program instructions and data that are necessary for a server or a communication device. The chip system may include a chip, or may include a chip and another discrete component.

### BRIEF DESCRIPTION OF DRAWINGS

FIG. 1a is a diagram of a structure of a sound signal processing device according to an embodiment of this application;

FIG. 1b is a diagram of an orientation in which a second bone conduction sensor is worn according to an embodiment of this application;

FIG. 2 is a diagram of a structure of a sound signal processing device according to an embodiment of this application;

FIG. 3 is a diagram of a structure of a sound signal processing device according to an embodiment of this application;

FIG. 4 is a diagram of a structure of a sound signal processing device according to an embodiment of this application;

FIG. 5 is a diagram of a structure of a sound signal processing device according to an embodiment of this application;

FIG. 6 is a schematic flowchart of a sound signal processing method according to an embodiment of this application;

FIG. 7 is a diagram of a second sound signal and a fourth sound signal according to an embodiment of this application;

FIG. 8 is a diagram of a comparison between a first sound signal and a noise-reduced first sound signal according to an embodiment of this application;

FIG. 9 is a diagram of a structure of a hat according to an embodiment of this application;

FIG. 10 is a diagram of a structure of a sound signal processing apparatus according to an embodiment of this application; and

FIG. 11 is a diagram of a structure of an electronic device according to an embodiment of this application.

### DESCRIPTION OF EMBODIMENTS

In the specification, claims, and accompanying drawings of this application, the terms “first”, “second”, and the like are intended to distinguish between similar objects but do not necessarily indicate a specific order or sequence. It should be understood that the terms used in such a way are interchangeable in proper circumstances, which is merely a discrimination manner that is used when objects having a same attribute are described in embodiments of this application. In addition, the terms “include”, “contain” and any other variants mean to cover a non-exclusive inclusion, so that a process, method, system, product, or device that includes a series of units is not necessarily limited to those units, but may include other units not expressly listed or inherent to such a process, method, system, product, or device.

The following describes embodiments of this application with reference to the accompanying drawings. A person of ordinary skill in the art may learn that, with development of technologies and emergence of a new scenario, the technical solutions provided in embodiments of this application are also applicable to a similar technical problem.

The solutions provided in embodiments of this application may be applied to various sound acquisition scenarios, and optionally, may be applied to a noise environment. For example, when a sound producer works in a workshop, a machine in the workshop may produce a noise. For another example, when the sound producer works around an electronic device such as a base station, the electronic device may produce a noise. For another example, when the sound producer works in an environment such as a coal mine, a large quantity of noises exist in the environment, and the like. Application scenarios of this solution are not exhaustive herein.

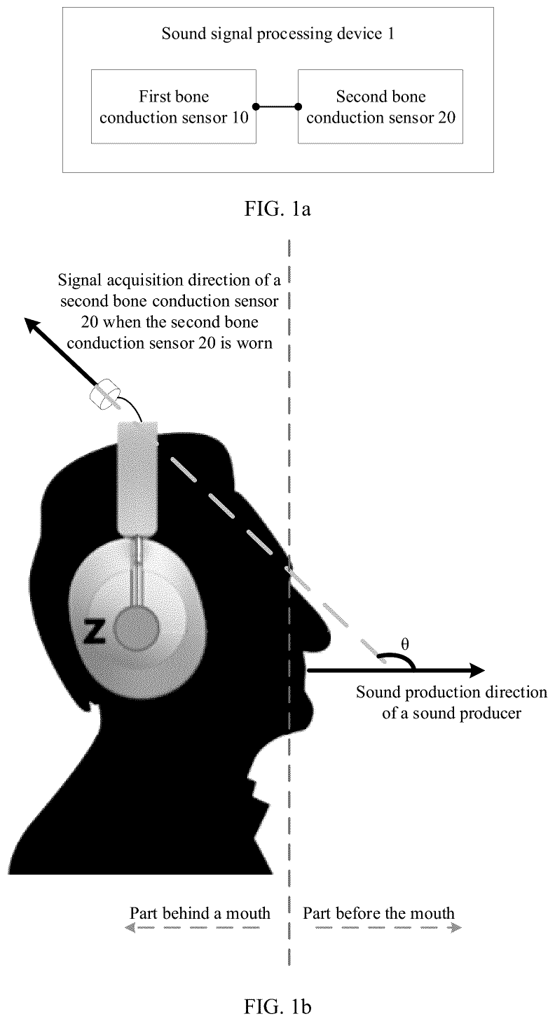

To obtain a cleaner sound signal, refer to FIG. 1a. FIG. 1a is a diagram of a structure of a sound signal processing device according to this application. As shown in FIG. 1a, the sound signal processing device 1 includes a first bone conduction sensor 10 and a second bone conduction sensor 20. The first bone conduction sensor 10 is in contact with a sound producer, and is configured to acquire a sound at a first time, to obtain a first sound signal. That is, the first bone conduction sensor 10 is configured to acquire a voice produced by the sound producer. The second bone conduction sensor 20 is not in contact with the sound producer, and is configured to acquire a second sound signal at the first time. In other words, the first bone conduction sensor 10 and the second bone conduction sensor 20 may synchronously perform a sound acquisition operation, and the second bone conduction sensor 20 is configured to acquire an ambient noise. The second sound signal is used to perform noise reduction on the first sound signal.

An included angle between a signal acquisition direction of the second bone conduction sensor 20 when the second bone conduction sensor 20 is worn and a sound production direction of the sound producer is greater than or equal to a preset angle threshold, and the preset angle threshold is greater than or equal to 90 degrees. In an embodiment, the included angle between the signal acquisition direction of the second bone conduction sensor 20 when the second bone conduction sensor 20 is worn and the sound production direction of the sound producer is equal to 180 degrees.

For example, the signal acquisition direction of the second bone conduction sensor 20 when the second bone conduction sensor 20 is worn may be an orientation in which the second bone conduction sensor 20 is worn, and the sound production direction of the sound producer may be an orientation of a mouth of the sound producer. It should be noted that because the second bone conduction sensor 20 and the mouth of the sound producer may be located in different horizontal planes or different vertical planes, when the included angle between the signal acquisition direction of the second bone conduction sensor 20 when the second bone conduction sensor 20 is worn and the sound production direction of the sound producer is measured, the signal acquisition direction of the second bone conduction sensor 20 when the second bone conduction sensor 20 is worn and the sound production direction of the sound producer may be mapped to a same vertical plane or horizontal plane.

In an embodiment, with the orientation of the mouth of the sound producer as the front, a position at which the second bone conduction sensor 20 is worn corresponds to a position of a part behind the mouth of the sound producer. Because the second bone conduction sensor 20 is not in contact with the sound producer, that “a position at which when the second bone conduction sensor 20 is worn corresponds to a position of a part behind the mouth of the sound producer” may mean that the position at which the second bone conduction sensor 20 is worn is above the position of the part behind the mouth of the sound producer.

For more intuitive understanding of this solution, refer to FIG. 1b. FIG. 1b is a diagram of an orientation in which the second bone conduction sensor is worn according to an embodiment of this application. In FIG. 1b, an example in which the signal acquisition direction of the second bone conduction sensor 20 when the second bone conduction sensor 20 is worn and the sound production direction of the sound producer are mapped to a same vertical plane is used. As shown in FIG. 1b, the signal acquisition direction of the second bone conduction sensor 20 when the second bone conduction sensor 20 is worn may be the orientation of the second bone conduction sensor 20, and the sound production direction of the sound producer may be the orientation of the mouth of the sound producer. θ in FIG. 1b represents the included angle between the signal acquisition direction of the second bone conduction sensor 20 when the second bone conduction sensor 20 is worn and the sound production direction of the sound producer, and a value of θ is greater than 90 degrees. In addition, FIG. 1b also shows a part before the mouth of the sound producer and a part behind the mouth of the sound producer. It should be understood that FIG. 1b is merely for ease of understanding, and is not intended to limit this solution.

In embodiments of this application, a person skilled in the art finds in an experiment that some noises in an environment can penetrate a bone conduction sensor, that is, an ambient noise exists in a sound signal acquired by the bone conduction sensor. Both the first bone conduction sensor and the second bone conduction sensor acquire sounds at the first time. Because the first bone conduction sensor is in contact with the sound producer, the first sound signal carries a voice signal generated by the sound producer and the ambient noise. Because the second bone conduction sensor is not in contact with the sound producer, the second sound signal acquired by the second bone conduction sensor carries a large quantity of ambient noises. Noise reduction is performed on the first sound signal by using the second sound signal, which helps remove the ambient noise from the first sound signal, to obtain a cleaner voice signal. In addition, if the included angle between the signal acquisition direction of the second bone conduction sensor when the second bone conduction sensor is worn and the sound production direction of the sound producer is greater than or equal to 90 degrees, a voice produced by the sound producer cannot directly enter the second bone conduction sensor through air, and needs to be reflected in the air for at least one time before being acquired by the second bone conduction sensor. This helps reduce a possibility that the second sound signal carries the voice signal, and helps avoid removing the voice signal from the first sound signal, to obtain a high-quality voice signal.

In an embodiment, the sound signal processing device 1 may be represented as a wearable device. For example, the sound signal processing device 1 may be a hat, an eye mask, a headset, or another product form. This is not limited herein.

There may be one or more first bone conduction sensors 10 in the sound signal processing device 1, and each first bone conduction sensor 10 is in contact with the sound producer. For example, each first bone conduction sensor 10 is closely attached to the sound producer. In an embodiment, if there are a plurality of first bone conduction sensors 10 in the sound signal processing device 1, different first bone conduction sensors 10 may be disposed at different positions. For example, each first bone conduction sensor 10 may be in contact with any one of the following positions on the sound producer: a forehead, a lower jawbone, a nasal alar cartilage, a temple, a vocal cord, another position at which a sound signal of the sound producer can be acquired, or the like. A specific position of the bone conduction sensor may be determined with reference to an actual application scenario, which is not limited herein.

For example, the sound signal processing device 1 is represented as the hat, and the first bone conduction sensor 10 may be fastened to a front part of a hat lining. In an embodiment, the first bone conduction sensor 10 may be installed at a middle position of the front part of the hat lining, and is in contact with the forehead of the sound producer. Alternatively, the hat (that is, an example of the sound signal processing device 1) may further include a sensor structure frame. The sensor structure frame includes an ear-mounted area, and the first bone conduction sensor 10 may be fastened to the ear-mounted area and is in contact with the lower jawbone of the sound producer. Alternatively, the first bone conduction sensor 10 may be fastened to a left side or a right side of the hat lining, and is in contact with the temple of the sound producer, or the like. This is not exhaustive herein.

For another example, the sound signal processing device 1 is represented as the eye mask. For example, when the sound signal processing device 1 is a device such as a virtual reality (VR) device, goggles, or glasses, the sound signal processing device 1 may be represented as the eye mask. The first bone conduction sensor 10 may be fastened to a nose pad area on an inner side of the eye mask, and is in contact with the nasal alar cartilage of the sound producer. Alternatively, the first bone conduction sensor 10 may be fastened to a left area or a right area on the inner side of the eye mask, and is in contact with the temple of the sound producer, or the like. For another example, the sound signal processing device 1 is represented as the headset. There is a connection band between two earpieces of the headset. The first bone conduction sensor 10 may be fastened to the connection band close to a left earpiece (or a right earpiece), and is in contact with the temple of the sound producer. The example herein is merely for ease of understanding. A specific position of the first bone conduction sensor 10 may be determined with reference to an actual application scenario. This is not limited herein.

There may be one or more second bone conduction sensors 20 in the sound signal processing device 1. Each second bone conduction sensor 20 is not in contact with the sound producer. The included angle between the signal acquisition direction of the second bone conduction sensor 20 when the second bone conduction sensor 20 is worn and the sound production direction of the sound producer is greater than or equal to the preset angle threshold, and the preset angle threshold is greater than or equal to 90 degrees. For example, the sound signal processing device 1 is represented as the hat, and the second bone conduction sensor 20 may be fastened to a brim of the hat. In an embodiment, the second bone conduction sensor 20 may be fastened to a rear part of the brim of the hat. The second bone conduction sensor 20 may be fastened to a middle position of the rear part of the brim of the hat, or may be fastened to another position on the rear part of the brim of the hat.

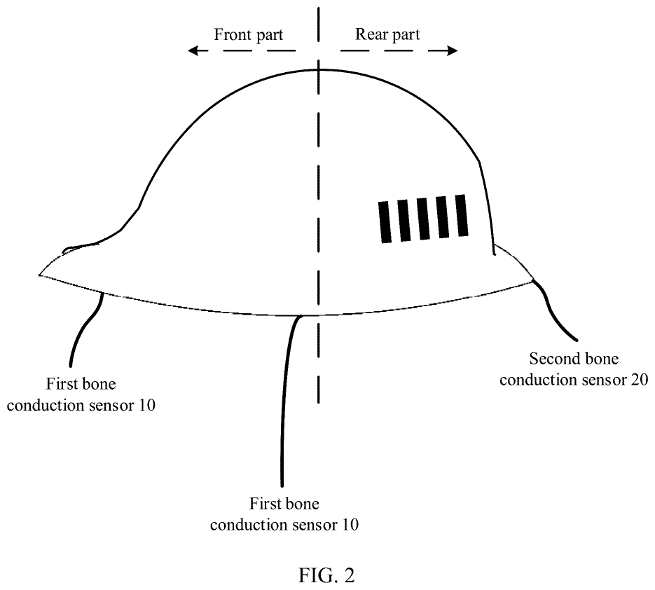

Further, the second bone conduction sensor 20 may be connected to the rear part of the brim of the hat in a hard connection manner. For example, the second bone conduction sensor 20 may be fastened to the rear part of the brim of the hat by using a screw and a nut. For another example, the second bone conduction sensor 20 may be fastened to the rear part of the brim of the hat by using a binder. Connection manners are not exhaustive herein. Alternatively, the second bone conduction sensor 20 may be connected to the rear part of the brim of the hat in a soft connection manner. For example, the second bone conduction sensor 20 may be fastened to the rear part of the brim of the hat by using a flexible connection band such as a copper stranded wire, tin-plated copper, or another material. One end of the flexible connection band is attached to the rear part of the brim of the hat, and the other end is connected to the second bone conduction sensor 20. This is not exhaustive herein. For more intuitive understanding of this solution, refer to FIG. 2. FIG. 2 is a diagram of a structure of a sound signal processing device according to an embodiment of this application. In FIG. 2, the hat is used as an example of the sound signal processing device 1. As shown in the figure, one first bone conduction sensor 10 in FIG. 2 is located in the middle position of the front part of the hat lining, and a position of the other first bone conduction sensor 10 corresponds to a position of an ear of a user. The second bone conduction sensor 20 is fastened to the rear part of the brim of the hat. It should be understood that the example in FIG. 2 is merely for ease of understanding of this solution, and is not intended to limit this solution. In this embodiment of this application, the brim of the hat is not in contact with the sound producer, and therefore the second bone conduction sensor fastened to the rear part of the brim of the hat is also not in contact with the sound producer. Because the sound producer faces in a same direction as a front part of the brim of the hat, fastening the second bone conduction sensor to the rear part of the brim of the hat helps further enlarge a distance between the second bone conduction sensor and the sound producer, to further reduce a probability that the second bone conduction sensor acquires an effective voice signal. This avoids a possibility that an effective voice signal in the first sound signal is eliminated or weakened in a process of performing noise reduction on the first sound signal by using the second sound signal, to obtain a higher-quality first sound signal.

For another example, the sound signal processing device 1 is represented as the headset. There is a connection band between two earpieces of the headset. The second bone conduction sensor 20 may be connected to the connection band in a soft connection manner, or the like. This is not exhaustive herein. For more intuitive understanding of this solution, refer to FIG. 3. FIG. 3 is a diagram of a structure of a sound signal processing device according to an embodiment of this application. In FIG. 3, the headset is used as an example of the sound signal processing device 1. As shown in the figure, both the first bone conduction sensor 10 and the second bone conduction sensor 20 may be connected to the connection band of the headset. The first bone conduction sensor 10 may correspond to a position of the lower jawbone of the user, and the second bone conduction sensor 20 may be connected to the connection band of the headset in a soft connection manner. It should be understood that the example in FIG. 3 is merely for ease of understanding of this solution, and is not intended to limit this solution.

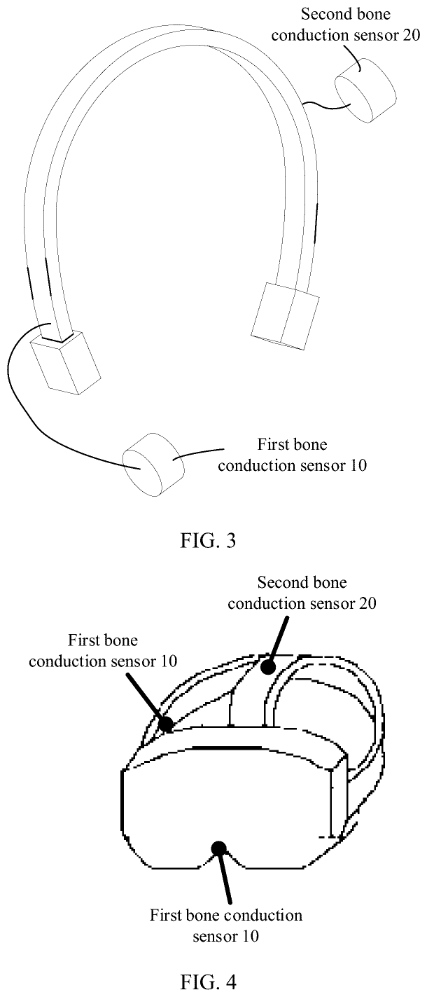

For another example, to fasten the sound signal processing device 1 in a form of the eye mask such as the VR device or the goggles to the head of the user, the sound signal processing device 1 may include the connection band, and wearing tightness of the sound signal processing device 1 can be adjusted by adjusting the connection band. The second bone conduction sensor 20 may be connected to the connection band of the eye mask in a soft connection manner. Alternatively, the second bone conduction sensor 20 may be connected to a housing of the VR device in a soft connection manner, or the like. This is not exhaustive herein. For more intuitive understanding of this solution, refer to FIG. 4. FIG. 4 is a diagram of a structure of a sound signal processing device according to an embodiment of this application. In FIG. 4, the VR device is used as an example of the sound signal processing device 1. As shown in the figure, one first bone conduction sensor 10 in FIG. 4 is fastened to a nose pad area of the VR device, and the other first bone conduction sensor 10 is located in a left area of an inner side of the VR device. The second bone conduction sensor 20 is connected to the housing of the VR device in a soft connection manner. It should be understood that the example in FIG. 4 is merely for ease of understanding of this solution, and is not intended to limit this solution. It should be noted that specific product forms of the sound signal processing device 1, the first bone conduction sensor 10, and the second bone conduction sensor 20 may all be determined with reference to an actual application scenario. This is not limited herein.

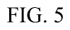

In an embodiment, FIG. 5 is a diagram of a structure of a sound signal processing device according to an embodiment of this application. The sound signal processing device 1 may further include a processor 30. For example, the processor 30 includes a synchronization processing chip, and the processor 30 controls both the first bone conduction sensor 10 and the second bone conduction sensor 20 to acquire sounds at the first time.

In an embodiment, the processor 30 is further configured to perform noise reduction on the first sound signal by using the second sound signal, to obtain a noise-reduced first sound signal.

In an embodiment, the sound signal processing device 1 may further include a communication module 40. The communication module 40 is configured to communicatively connect to another communication device. The foregoing communication manner may be wired communication or wireless communication. For example, the communication module 40 may be specifically represented as a Bluetooth communication module or another mode of communication module. This is not exhaustive herein. For example, the another communication device may be a mobile phone, a tablet computer, a notebook computer, an Internet of Things device, or another type of communication device. This may be specifically determined flexibly with reference to an actual application scenario, and is not limited herein.

In an embodiment, the communication module 40 may send the noise-reduced first sound signal to the another communication device. In another embodiment, the communication module 40 may send the first sound signal and the second sound signal to the another communication device, so that a processor of the another communication device performs “noise reduction on the first sound signal by using the second sound signal”.

In an embodiment, the sound signal processing device 1 may further include a speaker 50. The communication module 40 is configured to receive a sound signal sent by the another communication device, and transmit the sound signal to a wearer of the sound signal processing device 1 by using the speaker 50. For example, the speaker 50 may be a bone conduction speaker or another type of speaker. This is not exhaustive herein. Further optionally, the speaker 50 is specifically represented as the bone conduction speaker. In an embodiment, the speaker 50 may include at least two bone conduction speakers, and different bone conduction speakers in the at least two bone conduction speakers may be fastened to different positions on the sound signal processing device 1, that is, are in contact with different positions on the wearer. For example, a bone conduction speaker may be in contact with any one of the following positions on the wearer: a protrusion area behind an ear, an auricular concha area, a helix area, or another area. This is not exhaustive herein. One of the at least two bone conduction speakers may be selected for use, or the at least two bone conduction speakers may be used at the same time. This may be specifically determined with reference to an actual application scenario, and is not limited herein.

For example, the at least two bone conduction speakers may include a first bone conduction speaker and a second bone conduction speaker. If the sound signal processing device 1 may be the hat, both the first bone conduction speaker and the second bone conduction speaker may be fastened to a sensor architecture on the hat lining. For example, the first bone conduction speaker may be in contact with an auricular concha area in an ear of the wearer, and the second bone conduction speaker may be in contact with a protrusion position behind the ear of the wearer. It should be noted that the examples herein are merely used to prove implementability of this solution. If the sound signal processing device 1 is specifically represented as earmuffs, the eye mask, or another product form, a quantity and fixed positions of speakers 50 may be flexibly set based on an actual product form. This is not exhaustive herein.

It should be noted that, in an actual application scenario, the sound signal processing device 1 may include more or fewer components. The foregoing description of the sound signal processing device 1 is merely for ease of understanding of this solution, and is not intended to limit this solution. A specific implementation procedure of a sound signal processing method provided in embodiments of this application is described below.

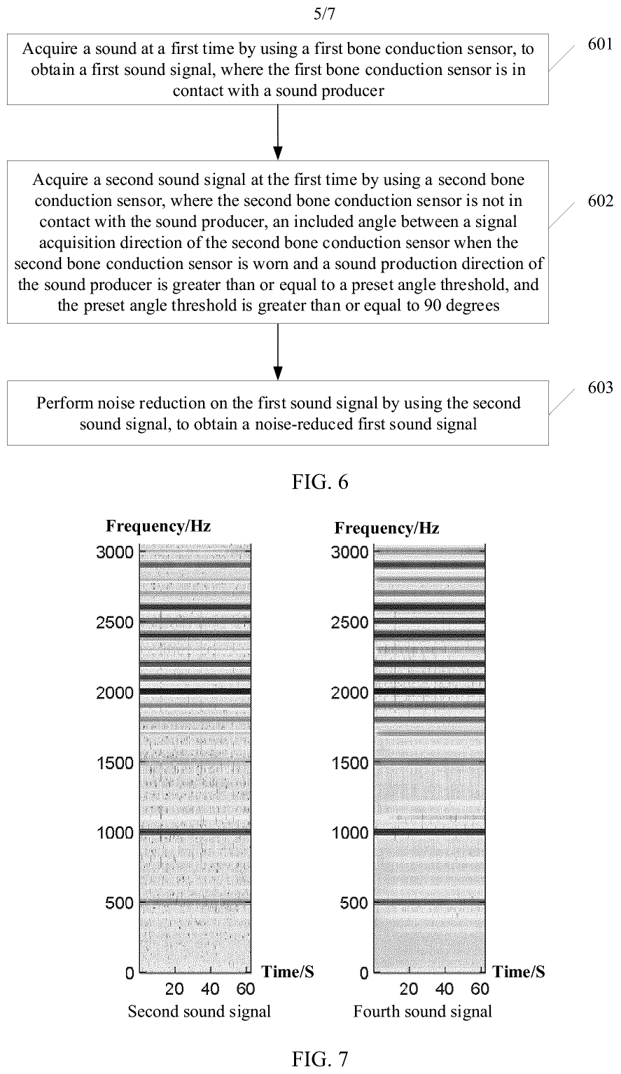

Specifically, FIG. 6 is a schematic flowchart of a sound signal processing method according to an embodiment of this application. The sound signal processing method provided in this embodiment of this application may include operations 601 to 603.

Operation 601: Acquire a sound at a first time by using a first bone conduction sensor, to obtain a first sound signal, where the first bone conduction sensor is in contact with a sound producer.

In this embodiment of this application, a processor may acquire the sound at the first time by using each of at least one first bone conduction sensor, to obtain the first sound signal. The first bone conduction sensor is in contact with the sound producer.

If there are at least two first bone conduction sensors in the at least one first bone conduction sensor, the processor may acquire one third sound signal at the first time by using each of the at least two first bone conduction sensors, to obtain at least two third sound signals that are in a one-to-one correspondence with the at least two first bone conduction sensors. The processor may obtain the first sound signal based on the at least two third sound signals. A horizontal coordinate of the third sound signal may be time, and a vertical coordinate of the third sound signal may be an amplitude value. For example, the horizontal coordinate of the third sound signal may be a sampling point, a time point, another type of time scale, or the like. A scale unit of the time point may be a second, a millisecond, a unit of another granularity, or the like. A representation form of the third sound signal may be determined with reference to an actual application scenario, and is not limited herein.

The processor may implement “determining the first sound signal based on the at least two third sound signals” in a plurality of manners. In an embodiment, the processor may perform weighted summation on the at least two third sound signals, to obtain the first sound signal.

In an embodiment, after obtaining the at least two third sound signals, the processor may further screen, based on energy of the at least two third sound signals acquired by the at least two first bone conduction sensors, the at least two third sound signals to obtain at least one selected third sound signal. Specifically, the processor may discard at least one target sound signal from the at least two third sound signals acquired by the at least two first bone conduction sensors, to obtain the at least one selected third sound signal. Energy of each target sound signal meets a first condition. The processor is specifically configured to obtain the first sound signal based on the at least one selected third sound signal.

Energy of one sound signal may reflect a strength of the sound signal. A weaker acquired sound signal indicates lower energy of the sound signal, and a stronger acquired sound signal indicates higher energy of the sound signal. The processor may perform weighted summation on only the at least one selected third sound signal to obtain the first sound signal, to discard the target sound signal. Alternatively, the processor may set a weight of each target sound signal to 0 when performing weighted summation on the at least two obtained third sound signals, to discard the target sound signal, and the like. This is not exhaustive herein.

In this embodiment of this application, in a wearing process of a sound signal processing device, a case in which a specific first bone conduction sensor is not closely attached to the sound producer may occur. Therefore, a sound of the sound producer carried in one third sound signal acquired by the first bone conduction sensor is quite weak, and a weak target sound signal can be determined from the at least two third sound signals based on energy of the sound signal, to discard the target sound signal. This helps improve quality of the finally obtained first sound signal, thereby helping improve quality of the noise-reduced first sound signal.

The processor may determine, in a plurality of manners, whether any third sound signal (for ease of description, hereinafter referred to as a “fifth sound signal”) meets the first condition. In an embodiment, the processor may obtain a first average value of energy of at least one third sound signal other than the fifth sound signal in the at least two third sound signals. The processor may determine whether a gap between energy of the fifth sound signal and the first average value meets the first condition; and if a determining result is that the gap between the energy of the fifth sound signal and the first average value meets the first condition, determine the fifth sound signal as the target sound signal that needs to be discarded; or if a determining result is that the gap between the energy of the fifth sound signal and the first average value does not meet the first condition, determine that the fifth sound signal does not need to be discarded. The processor performs the foregoing operations on each of the at least two third sound signals, to obtain the at least one selected third sound signal.

The processor may determine energy of one sound signal in a plurality of manners. In an embodiment, the processor may obtain, from one sound signal, H+1 amplitude values that are in a one-to-one correspondence with H+1 consecutive sampling points, and determine a square of a difference between the largest value and the smallest value in the H+1 amplitude values as energy of the sound signal. H is an integer greater than or equal to 1. In another embodiment, the processor may obtain, from one sound signal, H+1 amplitude values that are in a one-to-one correspondence with H+1 consecutive sampling points, and determine a variance of the H+1 amplitude values as energy of the sound signal, or the like. The processor may further calculate energy of each sound signal in another manner. This is not exhaustive herein.

For example, the H+1 consecutive sampling points may be H+1 consecutive sampling points before a current moment in the sound signal, or may be H+1 consecutive sampling points after the current moment in the sound signal, or may be H+1 consecutive sampling points randomly obtained from the sound signal, or the like. Specifically, the H+1 consecutive sampling points may be obtained with reference to an actual application scenario. This is not limited herein.

The “gap between the energy of the fifth sound signal and the first average value” may be a difference between the energy of the fifth sound signal and the first average value, and the first condition may be that the difference between the energy of the fifth sound signal and the first average value is greater than or equal to a first threshold. The first threshold may be the first average value multiplied by a preset proportion. For example, the preset proportion may be 80 percent, 90 percent, another value, or the like. Alternatively, the first threshold may be pre-stored in the processor, or the like. Alternatively, the “gap between the energy of the fifth sound signal and the first average value” may be a ratio of the energy of the fifth sound signal to the first average value, and the first condition may be that the ratio of the energy of the fifth sound signal to the first average value is less than or equal to a second threshold. For example, a value of the second threshold may be 10 percent, 5 percent, another value, or the like. The first condition is not exhaustive herein.

For more intuitive understanding of this solution, the following discloses an example of a formula for determining whether any third sound signal meets the first condition:

$$S = \frac{{\sum }_{m = 1}^{M} {\hat{d}}_{m}^{2} ( n ) - {\hat{d}}_{k}^{2} ( n )}{M - 1} - {\hat{d}}_{k}^{2} ( n ) ; \qquad ( 1 )$$

M represents that a quantity of third sound signals in the at least two third sound signals is M. \hat{d}ₖ(n) represents a difference between the largest value and the smallest value in H+1 amplitude values that are in a one-to-one correspondence with H+1 consecutive sampling points and that are in a kth third sound signal (that is, any third sound signal) of the M third sound signals, and \hat{d}ₖ²(n) represents a square of \hat{d}ₖ(n). A set formed by the H+1 amplitude values that are in a one-to-one correspondence with the H+1 consecutive sampling points and that are in the kth third sound signal includes {dₖ(n−H), dₖ(n−H+1), dₖ(n−H+2), . . . , dₖ(n)}. A meaning of \hat{d}ₘ²(n) is similar to a meaning of \hat{d}ₖ²(n). For understanding, refer to the foregoing descriptions. S represents a difference between the energy of the fifth sound signal and the first average value. It should be understood that the example in formula (1) is merely for ease of understanding of this solution, and is not intended to limit this solution.

In another embodiment, the processor may be configured with a third threshold, and the first condition includes that the energy of the fifth sound signal is less than or equal to the third threshold. The processor may determine whether the energy of the fifth sound signal is less than or equal to the third threshold; and if a determining result is that the energy of the fifth sound signal is less than or equal to the third threshold, determine the fifth sound signal as the target sound signal that needs to be discarded; or if a determining result is that the energy of the fifth sound signal is not less than or equal to the third threshold, determine that the fifth sound signal does not need to be discarded. The processor performs the foregoing operations on each of the at least two third sound signals, to obtain the at least one selected third sound signal.

When the processor performs weighted summation on the at least two third sound signals (or the at least one selected third sound signal), weight values of different third sound signals (or selected third sound signals) may be different. Alternatively, the weight values of the different third sound signals (or the selected third sound signals) may be the same, that is, the processor averages the at least two third sound signals (or the at least one selected third sound signal), to obtain the first sound signal. For example, a weight value of each third sound signal (or the selected third sound signal) of the at least two third sound signals (or the at least one selected third sound signal) may be 1. In this embodiment of this application, each third sound signal is acquired at the first time. That is, different first bone conduction sensors synchronously acquire third sound signals. Therefore, it may be considered that a plurality of third sound signals are synchronous (that is, aligned), and it is feasible to weight the plurality of third sound signals. In addition, a simple and effective implementation solution is provided. A hardware noise exists in each third sound signal, and the foregoing hardware noise is a Gaussian noise. Therefore, after different third sound signals are weighted, energy of the Gaussian noise does not increase, but energy of the effective voice signal in the sound signal increases, thereby helping improve a signal-to-noise ratio of the first sound signal.

The first sound signal is obtained by averaging the at least two third sound signals (or the at least one selected third sound signal). If there are X signals in the at least two third sound signals (or the at least one selected third sound signal), after the X signals are averaged, a Gaussian noise in the first sound signal becomes 1/X of the Gaussian noise in the third sound signal, to help alleviate, to the greatest extent, impact caused by the hardware noise.

In another embodiment, the processor may alternatively determine one of the at least two third sound signals as the first sound signal. For example, a third sound signal with maximum energy in the at least two third sound signals is determined as the first sound signal. For another example, one first sound signal is randomly selected from the at least two third sound signals, or the like. This is not exhaustive herein. If there is one first bone conduction sensor in the at least one first bone conduction sensor, operation 601 may include: The processor acquires one first sound signal at the first time by using one first bone conduction sensor.

Operation 602: Acquire a second sound signal at the first time by using a second bone conduction sensor, where the second bone conduction sensor is not in contact with the sound producer, an included angle between a signal acquisition direction of the second bone conduction sensor when the second bone conduction sensor is worn and a sound production direction of the sound producer is greater than or equal to a preset angle threshold, and the preset angle threshold is greater than or equal to 90 degrees.

In this embodiment of this application, the processor may acquire one second sound signal at the first time by using each of at least one second bone conduction sensor, to obtain at least one second sound signal that is in a one-to-one correspondence with the at least one second bone conduction sensor. The second bone conduction sensor is not in contact with the sound producer, the included angle between the signal acquisition direction of the second bone conduction sensor when the second bone conduction sensor is worn and the sound production direction of the sound producer is greater than or equal to the preset angle threshold, and the preset angle threshold is greater than or equal to 90 degrees. For a position and an orientation of the second bone conduction sensor in the sound signal processing device, refer to descriptions in the foregoing embodiment. Details are not described herein again.

If there is one second bone conduction sensor in the at least one second bone conduction sensor, the processor may acquire one second sound signal at the first time by using one second bone conduction sensor. If there are at least two second bone conduction sensors in the at least one second bone conduction sensor, the processor may select, from at least two second sound signals, one second sound signal used for performing a noise reduction operation.

Operation 603: Perform noise reduction on the first sound signal by using the second sound signal, to obtain a noise-reduced first sound signal.

In this embodiment of this application, the processor may perform the operation of “performing noise reduction on the first sound signal by using the second sound signal” in a plurality of manners. In an embodiment, the processor may input a second sound signal in a target time period and a first sound signal in the target time period to a first neural network, to obtain a noise-reduced first sound signal in the target time period. Then, the processor may perform noise reduction on a first sound signal in a next target time period. The first neural network is a neural network on which a training operation has been performed, and a value of the target time period may be 1 second, 3 seconds, 5 seconds, other duration, or the like. This is not limited herein.

In another embodiment, the processor may obtain a fourth sound signal from the second sound signal, and perform noise reduction on the first sound signal by using the fourth sound signal. The fourth sound signal includes a first narrowband noise (narrowband noise). For example, the first narrowband noise may be a periodic narrowband noise. Further, a narrowband noise has a center frequency and a bandwidth, and a bandwidth of a frequency band of the narrowband noise may be far less than the center frequency of the narrowband noise. For example, the bandwidth of the frequency band of the narrowband noise may be 30 percent, 25 percent, 20 percent, 15 percent, 10 percent, 5 percent, another value, or the like of the center frequency of the narrowband noise. It should be understood that the example herein is merely for ease of understanding of the concept of the “narrowband noise”. A specific relationship between “a bandwidth of a frequency band of a specific narrowband noise” and “a center frequency of the narrowband noise” may be flexibly determined based on an actual environment. This is not limited herein.

The periodic narrowband noise is a plurality of periodic sound waves existing in the first narrowband noise in the fourth sound signal, and center frequencies and bandwidths of same narrowband noises are similar or the same. In some application scenarios, one fourth sound signal may have two different periodic narrowband noises, and different narrowband noises mean different center frequencies and/or different bandwidths. Specifically, a case of a narrowband noise carried in the fourth sound signal is determined based on an actual application environment. This is not limited herein. For more intuitive understanding of this solution, refer to FIG. 7. FIG. 7 is a diagram of a second sound signal and a fourth sound signal according to an embodiment of this application. As an example, FIG. 7 discloses frequency domain graphs of the second sound signal and the fourth sound signal. Each wide bar in a left sub-diagram and a right sub-diagram of FIG. 7 represents a narrowband noise. As shown in the figure, the narrowband noise has a center frequency, and a bandwidth is relatively centralized. A bandwidth of a frequency band of the narrowband noise is far less than the center frequency of the narrowband noise. In the left sub-diagram of FIG. 7, there is still a small quantity of voice signals. The voice signals differ from narrowband noises in that waves of the voice signals span a relatively wide range of frequencies. In the left sub-diagram of FIG. 7, there are intermittent waves spanning a wide range of frequencies within a range of 2000 Hz. It should be noted that, because FIG. 7 is provided as a grayscale image, specific details are not as apparent as they are in a color image. It can be learned from a comparison between the left sub-diagram and the right sub-diagram of FIG. 7 that, after the second sound signal is processed, the narrowband noise in the fourth sound signal is enhanced, and the voice signal in the second sound signal is weakened. It should be understood that the example in FIG. 7 is merely for ease of understanding of a concept of “obtaining the first narrowband noise from the second sound signal”, and is not intended to limit this solution.

The processor may obtain the fourth sound signal from the second sound signal in a plurality of manners. In an embodiment, the processor may obtain the fourth sound signal from the second sound signal by using an adaptive filter. The fourth sound signal includes the first narrowband noise. For example, the adaptive filter may be a linear adaptive filter. Specifically, the processor may input the second sound signal delayed by D sampling points into the linear adaptive filter, to obtain a fourth sound signal output by the linear adaptive filter. In this embodiment of this application, the adaptive filter is used to obtain the fourth sound signal from the second sound signal. This not only provides a relatively simple implementation solution for obtaining the fourth sound signal from the second sound signal, but also can adaptively process the second sound signal in real time, so that a scenario, such as a call, that has a relatively high real-time requirement can be met, thereby helping expand implementation scenarios of this solution.

The adaptive filter is a filter that can automatically adjust performance based on an input sound signal, to perform digital signal processing, and a coefficient of the adaptive filter can be adaptively adjusted. For example, a quantity of coefficients in the adaptive filter is L, and L is an integer greater than or equal to 1. For example, a value of D is an integer multiple of L. In an embodiment, the value of D may be equal to L. Alternatively, the value of D may be equal to 2L, to reduce impact on device performance. For more intuitive understanding of this solution, the following discloses an example of formulas for obtaining the fourth sound signal by using the linear adaptive filter:

$${x}_{LP} ( n ) = {\sum }_{j = 0}^{L - 1} {h}_{j} ( n ) {X}_{back} ( n - D - j ) ; \qquad ( 2 )$$

$${e}_{LP} ( n ) = {X}_{back} ( n ) - {X}_{LP} ( n ) ; \qquad ( 3 )$$

$${h}_{j} ( n + 1 ) = {h}_{j} ( n ) + {μ}_{LP} {e}_{LP} ( n ) {X}_{back} ( n - D - j ) ; \qquad ( 4 )$$

x_{LP}(n) represents a value in the fourth sound signal output by the adaptive filter. hⱼ(n) represents a coefficient in the adaptive filter. Σⱼ₌₀^{L-1}hⱼ(n)X_{back}(n−D−j) means inputting X_{back}(n−D) to the adaptive filter with L coefficients and performing a convolution operation by using the adaptive filter. X_{back}(n−D) is the second sound signal delayed by D sampling points. For example, when it is expected to input X_{back}(1), a value of n is D+1, that is, an amplitude value of a (D+1)th sampling point in the second sound signal is obtained. Formula (3) is a cost function of the adaptive filter, where X_{back}(n) represents the second sound signal, and e_{LP}(n) represents an error between an input and an output of the adaptive filter. A purpose of updating a parameter of the adaptive filter includes continuously reducing the error. hⱼ(n+1) is a coefficient of the adaptive filter when a next value in X_{back}(n−D) is processed, and μ_{LP} represents a operation size for updating the coefficient of the adaptive filter. It should be noted that formulas (2) to (4) are formulas used when the coefficient of the adaptive filter is updated based on an idea of a least mean square (LMS) algorithm. In other embodiments, the coefficient of the adaptive filter may alternatively be updated based on an idea of a recursive least square (RLS) algorithm or another adaptive algorithm. The examples herein are merely used to prove implementability of this solution, and are not intended to limit this solution.

In another embodiment, the processor may input the second sound signal into a second neural network, to obtain a fourth sound signal output by the second neural network. The second neural network is a neural network on which a training operation has been performed, or the like. Alternatively, the processor may further obtain a periodic narrowband noise from the second sound signal by using another algorithm. This is not exhaustive herein.

In this embodiment of this application, when a decibel of a narrowband noise in an environment is excessively high, the narrowband noise can penetrate the bone conduction sensor, causing the bone conduction sensor to carry the narrowband noise in the environment. When the sound producer is in a scene near a factory building, an electronic device, or a coal mine, an engine, the electronic device, or the like can produce a high-decibel narrowband noise. As a result, the high-decibel narrowband noise penetrates the bone conduction sensor, causing interference to the acquired first sound signal. Because the second bone conduction sensor is not in contact with the sound producer, the narrowband noise in the environment exists in the second sound signal. The narrowband noise in the environment is obtained from the second sound signal, and noise reduction is performed on the first sound signal, so that a relatively clean voice signal can be obtained in the scene such as the factory building, the electronic device, or the coal mine. In other words, this solution can be adapted to a strong-noise application scenario such as the factory building, the electronic device, or the coal mine.

In a process of performing noise reduction on the second sound signal by using the fourth sound signal, the processor may adjust an amplitude and/or a phase of the fourth sound signal, to obtain an updated fourth sound signal, that is, adjust an amplitude and/or a phase of the first narrowband noise in the fourth sound signal, to obtain a second narrowband noise. The processor performs noise reduction on the first sound signal by using the updated fourth sound signal, that is, performs noise reduction on the first sound signal by using the second narrowband noise.

In this embodiment of this application, because an amplitude of a periodic narrowband noise in the first narrowband noise may be different from an amplitude of a periodic narrowband noise in the first sound signal, the amplitude of the fourth sound signal is adjusted, which helps improve consistency between amplitudes of the second narrowband noise in the updated fourth sound signal and the periodic narrowband noise in the first sound signal, thereby helping improve quality of a noise-reduced first sound signal. The phase of the fourth sound signal is adjusted, which helps implement alignment between the second narrowband noise in the updated fourth sound signal and the periodic narrowband noise in the first sound signal in a phase dimension, thereby helping improve quality of the noise-reduced first sound signal.

The processor may implement “performing noise reduction on the first sound signal by using the updated fourth sound signal” in a plurality of manners. In an embodiment, the processor may subtract the updated fourth sound signal from the first sound signal, to obtain the noise-reduced first sound signal. In another embodiment, the processor may obtain an inverted signal of the updated fourth sound signal, and add the first sound signal and the inverted signal, to obtain the noise-reduced first sound signal.

The processor may implement “adjusting the amplitude and/or the phase of the fourth sound signal” in a plurality of manners. In an embodiment, the processor may input the fourth sound signal and the first sound signal to an adaptive noise canceller, to obtain an updated fourth sound signal output by the adaptive noise canceller, that is, input the first narrowband noise in the fourth sound signal and the first sound signal to the adaptive noise canceller, to obtain the updated fourth sound signal output by the adaptive noise canceller. The updated fourth sound signal includes a second narrowband signal. The adaptive noise canceller is an application manner of the adaptive filter. That is, the adaptive noise canceller may be an adaptive filter. In this embodiment of this application, the adaptive noise canceller is used to adjust the amplitude and/or the phase of the fourth sound signal. That is, the adaptive noise canceller is used to adjust an amplitude and/or a phase of a first narrowband signal in the fourth sound signal. This provides a relatively simple implementation solution, and can adaptively process the first narrowband signal in real time, so that a scenario, such as a call, that has a relatively high real-time requirement can be met, thereby helping expand implementation scenarios of this solution.

For more intuitive understanding of this solution, the following discloses an example of formulas for adjusting the amplitude and/or the phase of the fourth sound signal by using the adaptive noise canceller:

$${y}_{PxLMS} ( n ) = {\sum }_{i = 0}^{T - 1} {w}_{i} ( n ) {x}_{LP} ( n - i ) ; \qquad ( 5 )$$

$${e}_{PxLMS} ( n ) = d {-}_{\sum } ( n ) - {y}_{PxLMS} ( n ) ; \qquad ( 6 )$$

$${w}_{i} ( n + 1 ) = {w}_{i} ( n ) + {μ}_{PxLMS} {e}_{PxLMS} ( n ) {x}_{LP} ( n - i ) ; \qquad ( 7 )$$

y_{P×LMS}(n) represents a value in the updated fourth sound signal output by the adaptive noise canceller. wᵢ(n) represents a coefficient in the adaptive noise canceller. Σᵢ₌₀^{T-1}wᵢ(n)x_{LP}(n−i) means inputting x_{LP}(n) to the adaptive noise canceller with T coefficients and performing a convolution operation by using the adaptive noise canceller. For example, a value of T is equal to a value of L.

$${e}_{PxLMS} ( n ) = d {-}_{\sum } ( n ) - {y}_{PxLMS} ( n )$$

represents a cost function of the adaptive noise canceller, where

$$d {-}_{\sum } ( n )$$

represents the first sound signal, and e_{P×LMS}(n) represents a difference between the first sound signal and y_{P×LMS}(n). wᵢ(n+1) is a coefficient of the adaptive noise canceller when a next value in x_{LP}(n) is processed, and μ_{P×LMS} represents a operation size for updating the coefficient of the adaptive noise canceller. A purpose of updating the coefficient of the adaptive noise canceller includes enabling e_{P×LMS}(n) to be used as a pure voice during voice communication. It should be noted that formulas (5) to (7) are formulas used when the coefficient of the adaptive noise canceller is updated based on the idea of the LMS algorithm. In other embodiments, the coefficient of the adaptive noise canceller may alternatively be updated based on the idea of the RLS algorithm or another adaptive algorithm. The examples herein are merely used to prove implementability of this solution, and are not intended to limit this solution.

In another embodiment, the processor may alternatively input the second sound signal and the first sound signal into a third neural network, and adjust the amplitude and/or the phase of the fourth sound signal by using the third neural network, to obtain an updated fourth sound signal output by the third neural network. The updated fourth sound signal includes the second narrowband signal. The third neural network is a neural network on which a training operation has been performed. Alternatively, the processor may further adjust the amplitude and/or the phase of the fourth sound signal by using another algorithm. This is not exhaustive herein.

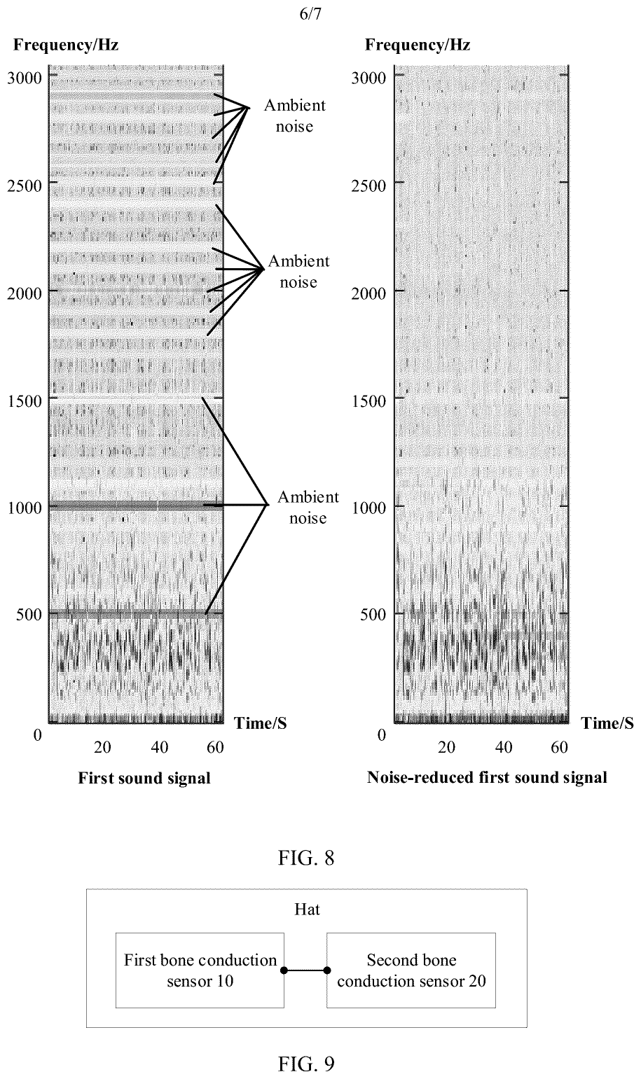

For more intuitive understanding of this solution, refer to FIG. 8. FIG. 8 is a diagram of a comparison between a first sound signal and a noise-reduced first sound signal according to an embodiment of this application. FIG. 8 includes two sub-diagrams: a left sub-diagram and a right sub-diagram. The left sub-diagram of FIG. 8 represents the first sound signal, and the right sub-diagram of FIG. 8 represents the noise-reduced first sound signal. As an example, FIG. 8 shows frequency domain graphs of the first sound signal and the noise-reduced first sound signal. In the left sub-diagram of FIG. 8 and the right sub-diagram of FIG. 8, horizontal coordinates are both time, and vertical coordinates are frequencies. First, refer to the left sub-diagram of FIG. 8. The first sound signal includes many wide bars (that is, ambient noises shown in FIG. 8) parallel to a horizontal axis. Each wide bar has a center frequency and a bandwidth, and each wide bar may be considered as one narrowband noise. The first sound signal shown in the left diagram of FIG. 8 further includes voice signals (waves within 1000 Hz in FIG. 8), and waves of the voice signals span a relatively wide range of frequencies. Different from narrowband noises, the voice signals do not have distinct center frequencies or bandwidths. It should be noted that different grayscales of different wide bars represent different energy of different narrowband noises in the first sound signal. It can be learned from a comparison between the left sub-diagram and the right sub-diagram of FIG. 8 that ambient noises in the noise-reduced first sound signal are greatly eliminated, and voice signals are more distinct. It should be understood that the example in FIG. 8 is merely for ease of understanding of this solution, and is not intended to limit this solution.

Based on embodiments corresponding to FIG. 1a to FIG. 8, to better implement the foregoing solutions in embodiments of this application, the following further provides related devices configured to implement the foregoing solutions. An embodiment of this application further provides a sound signal processing device 1. The sound signal processing device 1 includes a first bone conduction sensor 10 and a second bone conduction sensor 20. The first bone conduction sensor 10 is in contact with a sound producer, and the first bone conduction sensor 10 is configured to acquire a sound at a first time, to obtain a first sound signal. The second bone conduction sensor 20 is not in contact with the sound producer, and the second bone conduction sensor 20 is configured to acquire a second sound signal at the first time. The second sound signal is used to perform noise reduction on the first sound signal, an included angle between a signal acquisition direction of the second bone conduction sensor 20 when the second bone conduction sensor 20 is worn and a sound production direction of the sound producer is greater than or equal to a preset angle threshold, and the preset angle threshold is greater than or equal to 90 degrees.

In an embodiment, the sound signal processing device 1 further includes a processor 30. The processor 30 is configured to: obtain a first narrowband signal from the second sound signal, and perform noise reduction on the first sound signal by using the first narrowband signal. A bandwidth of a frequency band of a narrowband noise is less than a center frequency of the narrowband noise.

In an embodiment, the processor 30 is specifically configured to obtain the first narrowband signal from the second sound signal by using an adaptive filter.

In an embodiment, the processor 30 is specifically configured to: adjust an amplitude and/or a phase of the first narrowband signal to obtain a second narrowband noise, and perform noise reduction on the first sound signal by using the second narrowband noise.

In an embodiment, the processor 30 is specifically configured to input the first narrowband signal and the first sound signal into an adaptive noise canceller, to obtain a second narrowband noise that is output by the adaptive noise canceller.

In an embodiment, the sound signal processing device is a hat, and the second bone conduction sensor 20 is fastened to a rear part of a brim of the hat.

In an embodiment, there are at least two first bone conduction sensors 10, and each first bone conduction sensor 10 is specifically configured to acquire a third sound signal at the first time. The sound signal processing device 1 further includes a processor 30. The processor 30 is configured to screen, based on energy of at least two third sound signals acquired by the at least two first bone conduction sensors 10, the at least two third sound signals to obtain at least one selected third sound signal. The processor 30 is specifically configured to obtain the first sound signal based on the at least one selected third sound signal.

In an embodiment, there are at least two first bone conduction sensors 10, and each first bone conduction sensor 10 is specifically configured to acquire the third sound signal at the first time. The device further includes a processor 30. The processor 30 is configured to perform a weighted summation operation based on the at least two third sound signals acquired by the at least two first bone conduction sensors 10, to obtain the first sound signal.

In an embodiment, the processor 30 is specifically configured to perform an averaging operation based on the at least two third sound signals acquired by the at least two first bone conduction sensors 10, to obtain the first sound signal.

It should be noted that, for a specific structure of the sound signal processing device 1, refer to the descriptions in embodiments corresponding to FIG. 1a to FIG. 8. Content such as information exchange and an execution process between modules/units in the sound signal processing device 1 is based on a same concept as embodiments corresponding to FIG. 1a to FIG. 8 in this application. For specific content, refer to the descriptions in the foregoing method embodiment of this application. Details are not described herein again.

FIG. 9 is a diagram of a structure of a hat according to an embodiment of this application. The hat may include a first bone conduction sensor 10 and a second bone conduction sensor 20. The first bone conduction sensor 10 is in contact with a sound producer, and the second bone conduction sensor 20 is not in contact with the sound producer and is fastened to a rear part of a brim of the hat.

In an embodiment, the first bone conduction sensor 10 is configured to acquire a sound at a first time, to obtain a first sound signal. The second bone conduction sensor 20 is configured to acquire a second sound signal at the first time. The hat further includes a processor 30, configured to perform noise reduction on the first sound signal by using the second sound signal, to obtain a noise-reduced first sound signal.

It should be noted that content such as a specific structure of the hat and information exchange and an execution process between modules/units in the hat is based on a same concept as the foregoing embodiments of this application. For specific content, refer to the descriptions in the foregoing method embodiment of this application. Details are not described herein again.

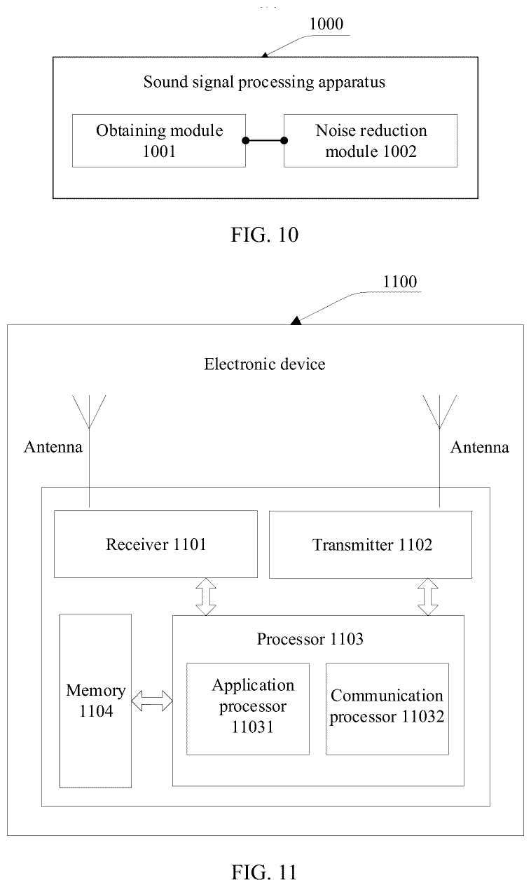

FIG. 10 is a diagram of a structure of a sound signal processing apparatus according to an embodiment of this application. The sound signal processing apparatus 1000 includes: an obtaining module 1001, configured to acquire a sound at a first time by using a first bone conduction sensor, to obtain a first sound signal, where the obtaining module 1001 is configured to acquire a second sound signal at the first time by using a second bone conduction sensor, where the first bone conduction sensor is in contact with a sound producer, and the second bone conduction sensor is not in contact with the sound producer, where an included angle between a signal acquisition direction of the second bone conduction sensor when the second bone conduction sensor is wom and a sound production direction of the sound producer is greater than or equal to a preset angle threshold, and the preset angle threshold is greater than or equal to 90 degrees; and a noise reduction module 1002, configured to perform noise reduction on the first sound signal by using the second sound signal, to obtain a noise-reduced first sound signal.

In an embodiment, the noise reduction module 1002 is specifically configured to: obtain a first narrowband signal from the second sound signal, and perform noise reduction on the first sound signal by using the first narrowband signal. A bandwidth of a frequency band of a narrowband noise is less than a center frequency of the narrowband noise.

In an embodiment, the noise reduction module 1002 is specifically configured to: adjust an amplitude and/or a phase of the first narrowband signal to obtain an updated first narrowband signal, and perform noise reduction on the first sound signal by using the updated first narrowband signal.

In an embodiment, there are at least two first bone conduction sensors, and the obtaining module 1001 is specifically configured to: screen, based on energy of at least two third sound signals acquired by the at least two first bone conduction sensors, the at least two third sound signals to obtain at least one selected third sound signal; and obtain the first sound signal based on the at least one selected third sound signal.

In an embodiment, there are at least two first bone conduction sensors, and the obtaining module 1001 is specifically configured to: acquire at least two third sound signals at the first time by using the at least two first bone conduction sensors; and perform a weighted summation operation based on the at least two third sound signals acquired by the at least two first bone conduction sensors, to obtain the first sound signal.

It should be noted that content such as information exchange and an execution process between modules/units in the sound signal processing apparatus 1000 is based on a same concept as the foregoing embodiments of this application. For specific content, refer to the descriptions in the foregoing method embodiment of this application. Details are not described herein again.

The following describes an electronic device according to an embodiment of this application. FIG. 11 is a diagram of a structure of an electronic device according to an embodiment of this application. The electronic device 1100 may be represented as the another communication device that is communicatively connected to the sound signal processing device 1 shown in FIG. 1a, for example, a mobile phone, a tablet computer, a notebook computer, or an Internet of Things device. This is not limited herein. Specifically, the electronic device 1100 includes a receiver 1101, a transmitter 1102, a processor 1103, and a memory 1104 (there may be one or more processors 1103 in the electronic device 1100, and one processor is used as an example in FIG. 11). The processor 1103 may include an application processor 11031 and a communication processor 11032. In some embodiments of this application, the receiver 1101, the transmitter 1102, the processor 1103, and the memory 1104 may be connected through a bus or in another manner.

The memory 1104 may include a read-only memory and a random access memory, and provide instructions and data to the processor 1103. Apart of the memory 1104 may further include a non-volatile random access memory (NVRAM). The memory 1104 stores a processor and operation instructions, an executable module or a data structure, a subset thereof, or an extended set thereof. The operation instructions may include various operation instructions for implementing various operations.

The processor 1103 controls an operation of the electronic device. During specific application, components of the electronic device are coupled together through a bus system. In addition to a data bus, the bus system may further include a power bus, a control bus, a status signal bus, and the like. However, for clear description, various types of buses in the figure are referred to as the bus system.

The method disclosed in the foregoing embodiment of this application may be applied to the processor 1103, or implemented by the processor 1103. The processor 1103 may be an integrated circuit chip and has a signal processing capability. In an embodiment process, operations in the foregoing method may be implemented by using a hardware integrated logic circuit in the processor 1103, or by using instructions in a form of software. The processor 1103 may be a general-purpose processor, a digital signal processor (DSP), a microprocessor or a microcontroller. The processor 1103 may further include an application-specific integrated circuit (ASIC), a field programmable gate array (FPGA) or another programmable logic device, a discrete gate or transistor logic device, or a discrete hardware component. The processor 1103 may implement or perform the methods, operations, and logic block diagrams disclosed in embodiments of this application. The general-purpose processor may be a microprocessor, or the processor may be any conventional processor or the like. Operations in the method disclosed with reference to embodiments of this application may be directly performed and completed by a hardware decoding processor, or may be performed and completed by using a combination of hardware in the decoding processor and a software module. A software module may be located in a mature storage medium in the art, such as a random access memory, a flash memory, a read-only memory, a programmable read-only memory, an electrically erasable programmable memory, or a register. The storage medium is located in the memory 1104, and the processor 1103 reads information in the memory 1104 and completes the operations in the foregoing method in combination with hardware of the processor.

The receiver 1101 may be configured to receive input digital or character information, and generate a signal input related to related settings and function control of the electronic device. The transmitter 1102 may be configured to output the digital or character information through a first interface. The transmitter 1102 may be further configured to send instructions to a disk group through the first interface, to modify data in the disk group. The transmitter 1102 may further include a display device such as a display.

In this embodiment of this application, the application processor 11031 in the processor 1103 is configured to perform the sound signal processing method performed by the processor in the foregoing method embodiments. It should be noted that a specific manner of performing the foregoing operations by the application processor 11031 is based on a same concept as the method embodiment in this application. Technical effects brought by the specific manner are the same as those of the method embodiment in this application. For specific content, refer to the descriptions in the foregoing method embodiment of this application. Details are not described herein again.

An embodiment of this application further provides a computer program product. When the computer program product runs on a computer, the computer is enabled to perform the operations performed by the processor in the method described in embodiments shown in FIG. 6 to FIG. 8.

An embodiment of this application further provides a computer-readable storage medium. The computer-readable storage medium stores a program used for signal processing. When the program is run on a computer, the computer is enabled to perform the operations performed by the processor in the method described in embodiments shown in FIG. 6 to FIG. 8.

The sound signal processing apparatus and the electronic device provided in embodiments of this application may be specifically a chip. The chip includes a processing unit and a communication unit. The processing unit may be, for example, a processor. The communication unit may be, for example, an input/output interface, a pin, or a circuit. The processing unit may execute computer-executable instructions stored in a storage unit, so that the chip performs the sound signal processing method described in embodiments shown in FIG. 6 to FIG. 8. In an embodiment, the storage unit is a storage unit in the chip, for example, a register or a cache. Alternatively, the storage unit may be a storage unit in a wireless access device end but outside the chip, for example, a read-only memory (ROM), another type of static storage device that can store static information and instructions, or a random access memory (RAM).

The processor mentioned anywhere above may be a general-purpose central processing unit, a microprocessor, an ASIC, or one or more integrated circuits that are configured to control program execution of the method according to the first aspect.

In addition, it should be noted that the described apparatus embodiment is merely an example. The units described as separate parts may or may not be physically separate, and parts displayed as units may or may not be physical units, may be located in one position, or may be distributed on a plurality of network units. Some or all of the modules may be selected according to actual needs to achieve the objectives of the solutions of embodiments. In addition, in the accompanying drawings of the apparatus embodiment provided in this application, connection relationships between modules indicate that the modules have communication connections with each other, which may be specifically implemented as one or more communication buses or signal cables.

Based on the description of the foregoing implementations, a person skilled in the art may clearly understand that this application may be implemented by software in addition to necessary universal hardware, or by dedicated hardware, including an application-specific integrated circuit, a dedicated CPU, a dedicated memory, a dedicated component, and the like. Usually, any function implemented by a computer program can be easily implemented by using corresponding hardware. In addition, specific hardware structures used to implement a same function may be various, for example, an analog circuit, a digital circuit, or a dedicated circuit. However, as for this application, software program implementation is a better implementation in most cases. Based on such an understanding, the technical solutions of this application essentially or the part contributing to the conventional technology may be implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (which may be a personal computer, a training device, a network device, or the like) to perform the method in embodiments of this application.

All or some of the foregoing embodiments may be implemented by using software, hardware, firmware, or any combination thereof. When software is used to implement embodiments, the foregoing embodiments may be implemented completely or partially in a form of a computer program product.

The computer program product includes one or more computer instructions. When the computer program instructions are loaded and executed on the computer, the procedures or functions according to the embodiments of this application are completely or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, a computer, a training device, or a data center to another website, computer, training device, or data center in a wired (for example, a coaxial cable, an optical fiber, or a digital subscriber line (DSL)) or wireless (for example, infrared, radio, or microwave) manner. The computer-readable storage medium may be any usable medium that can be stored by a computer, or a data storage device, for example, a training device or a data center, integrating one or more usable media. The usable medium may be a magnetic medium (for example, a floppy disk, a hard disk, or a magnetic tape), an optical medium (for example, a DVD), a semiconductor medium (for example, a solid state drive (SSD)), or the like.

1. A sound signal processing device, wherein the device comprising:
a first bone conduction sensor in contact with a sound producer, and is configured to acquire a sound at a first time, to obtain a first sound signal; and
a second bone conduction sensor not in contact with the sound producer, and is configured to acquire a second sound signal at the first time, wherein the second sound signal is used to perform noise reduction on the first sound signal, an included angle between a signal acquisition direction of the second bone conduction sensor when the second bone conduction sensor is worn and a sound production direction of the sound producer is greater than or equal to a preset angle threshold, and the preset angle threshold is greater than or equal to 90 degrees.

2. The device according to claim 1, further comprising:
a processor, configured to: obtain a first narrowband noise from the second sound signal, and perform noise reduction on the first sound signal by using the first narrowband noise, wherein a bandwidth of a frequency band of a narrowband noise is less than a center frequency of the narrowband noise.

3. The device according to claim 2, wherein
the processor is configured to obtain the first narrowband noise from the second sound signal by using an adaptive filter.

4. The device according to claim 2, wherein
the processor is configured to: adjust an amplitude and/or a phase of the first narrowband noise to obtain a second narrowband noise, and perform noise reduction on the first sound signal by using the second narrowband noise.

5. The device according to claim 4, wherein
the processor is configured to input the first narrowband noise and the first sound signal into an adaptive noise canceller, to obtain the second narrowband noise that is output by the adaptive noise canceller.

6. The device according to claim 1, wherein the sound signal processing device is a hat, and the second bone conduction sensor is fastened to a rear part of a brim of the hat.

7. The device according to claim 1, wherein the first bone conduction sensor comprises at least two first bone conduction sensors, and each first bone conduction sensor is configured to acquire a third sound signal at the first time;
wherein the device further comprises a processor configured to screen, based on energy of at least two third sound signals acquired by the at least two first bone conduction sensors, the at least two third sound signals to obtain at least one selected third sound signal; and
the processor is configured to obtain the first sound signal based on the at least one selected third sound signal.

8. The device according to claim 1, wherein the first bone conduction sensor comprises at least two first bone conduction sensors, and each first bone conduction sensor is configured to acquire a third sound signal at the first time; and
wherein the device further comprises a processor, configured to perform a weighted summation operation based on at least two third sound signals acquired by the at least two first bone conduction sensors, to obtain the first sound signal.

9. The device according to claim 8, wherein
the processor is configured to perform an averaging operation based on the at least two third sound signals acquired by the at least two first bone conduction sensors, to obtain the first sound signal.

10. A sound signal processing method, comprising:
acquiring a sound at a first time by using a first bone conduction sensor, to obtain a first sound signal;
acquiring a second sound signal at the first time by using a second bone conduction sensor, wherein the first bone conduction sensor is in contact with a sound producer, and the second bone conduction sensor is not in contact with the sound producer, wherein an included angle between a signal acquisition direction of the second bone conduction sensor when the second bone conduction sensor is worn and a sound production direction of the sound producer is greater than or equal to a preset angle threshold, and the preset angle threshold is greater than or equal to 90 degrees; and
performing noise reduction on the first sound signal by using the second sound signal, to obtain a noise-reduced first sound signal.

11. The method according to claim 10, wherein the performing noise reduction on the first sound signal by using the second sound signal comprises:
obtaining a first narrowband noise from the second sound signal, and performing noise reduction on the first sound signal by using the first narrowband noise, wherein a bandwidth of a frequency band of a narrowband noise is less than a center frequency of the narrowband noise.

12. The method according to claim 11, wherein the performing noise reduction on the first sound signal by using the first narrowband noise comprises:
adjusting an amplitude and/or a phase of the first narrowband noise to obtain a second narrowband noise, and performing noise reduction on the first sound signal by using the second narrowband noise.

13. The method according to claim 10, wherein the first bone conduction sensor comprises at least two first bone conduction sensors, and the acquiring a sound at a first time by using a first bone conduction sensor, to obtain a first sound signal comprises:
screening, based on energy of at least two third sound signals acquired by the at least two first bone conduction sensors at the first time, the at least two third sound signals to obtain at least one selected third sound signal; and
obtaining the first sound signal based on the at least one selected third sound signal.

14. The method according to claim 10, wherein the first bone conduction sensor comprises at least two first bone conduction sensors, and the acquiring a sound at a first time by using a first bone conduction sensor, to obtain a first sound signal comprises:
acquiring at least two third sound signals at the first time by using the at least two first bone conduction sensors; and
performing a weighted summation operation based on the at least two third sound signals acquired by the at least two first bone conduction sensors, to obtain the first sound signal.

15. A non-transitory computer-readable storage medium, comprising a program, wherein when the program is run on a computer, the computer is enabled to perform operations comprising:
acquiring a sound at a first time by using a first bone conduction sensor, to obtain a first sound signal;
acquiring a second sound signal at the first time by using a second bone conduction sensor, wherein the first bone conduction sensor is in contact with a sound producer, and the second bone conduction sensor is not in contact with the sound producer, wherein an included angle between a signal acquisition direction of the second bone conduction sensor when the second bone conduction sensor is worn and a sound production direction of the sound producer is greater than or equal to a preset angle threshold, and the preset angle threshold is greater than or equal to 90 degrees; and
performing noise reduction on the first sound signal by using the second sound signal, to obtain a noise-reduced first sound signal.

16. The computer-readable storage medium according to claim 15, wherein the performing noise reduction on the first sound signal by using the second sound signal comprises:
obtaining a first narrowband noise from the second sound signal, and performing noise reduction on the first sound signal by using the first narrowband noise, wherein a bandwidth of a frequency band of a narrowband noise is less than a center frequency of the narrowband noise.

17. The computer-readable storage medium according to claim 16, wherein the performing noise reduction on the first sound signal by using the first narrowband noise comprises:
adjusting an amplitude and/or a phase of the first narrowband noise to obtain a second narrowband noise, and performing noise reduction on the first sound signal by using the second narrowband noise.

18. The computer-readable storage medium according to claim 15, wherein there are at least two first bone conduction sensors, and the acquiring a sound at a first time by using a first bone conduction sensor, to obtain a first sound signal comprises:
screening, based on energy of at least two third sound signals acquired by the at least two first bone conduction sensors at the first time, the at least two third sound signals to obtain at least one selected third sound signal; and
obtaining the first sound signal based on the at least one selected third sound signal.

19. An electronic device, comprising a processor and a memory, wherein the processor is coupled to the memory;
the memory is configured to store a program; and
the processor is configured to execute the program in the memory, so that the electronic device performs operations comprising:
acquiring a sound at a first time by using a first bone conduction sensor, to obtain a first sound signal;
acquiring a second sound signal at the first time by using a second bone conduction sensor, wherein the first bone conduction sensor is in contact with a sound producer, and the second bone conduction sensor is not in contact with the sound producer, wherein an included angle between a signal acquisition direction of the second bone conduction sensor when the second bone conduction sensor is worn and a sound production direction of the sound producer is greater than or equal to a preset angle threshold, and the preset angle threshold is greater than or equal to 90 degrees; and
performing noise reduction on the first sound signal by using the second sound signal, to obtain a noise-reduced first sound signal.

20. The electronic device according to claim 19, wherein the performing noise reduction on the first sound signal by using the second sound signal comprises:
obtaining a first narrowband noise from the second sound signal, and performing noise reduction on the first sound signal by using the first narrowband noise, wherein a bandwidth of a frequency band of a narrowband noise is less than a center frequency of the narrowband noise.
